(19) United States
(12) Patent Application Publication
(10) Pub. No.: US 2023/0203278 A1
(43) Pub. Date: Jun. 29, 2023

(54) RUBBER COMPOSITION AND TIRE

(71) Applicant: Toyo Tire Corporation, Itami-shi (JP)

(72) Inventor: Shotaro Miwa, Itami-shi (JP)

(73) Assignee: Toyo Tire Corporation, Itami-shi (JP)

(21) Appl. No.: 17/983,582

(22) Filed: Nov. 9, 2022

(30) Foreign Application Priority Data
Dec. 27, 2021 (JP) 2021-213112

(51) Int. Cl. C08K 5/5455; C08K 5/5419; B60C 1/00

(52) U.S. Cl. CPC C08K 5/5455; C08K 5/5419; B60C 1/0016; B60C 1/0025

(57) ABSTRACT

A rubber composition according to an embodiment contains a diene rubber and silica. A value Dm/Rg obtained by dividing a mass fractal dimension Dm of a silica aggregate by an inertia radius Rg of the silica aggregate is 0.20 nm⁻¹ or more, the inertia radius Rg being obtained by irradiating a vulcanized rubber obtained by vulcanizing the rubber composition with X-rays to perform a small-angle X-ray scattering measurement, and the mass fractal dimension Dm being obtained by irradiating the vulcanized rubber with X-rays to perform an ultra-small angle X-ray scattering measurement.

### CROSS-REFERENCE TO RELATED APPLICATION

This application is based upon and claims the benefit of priority from the prior Japanese Patent Application No. 2021-213112, filed on Dec. 27, 2021; the entire contents of which are incorporated herein by reference.

### BACKGROUND OF THE INVENTION

### 1. Field of the Invention

The present invention relates to a rubber composition and a tire using the rubber composition.

### 2. Description of the Related Art

A tire is required to improve wet grip performance, which is grip performance on a wet road surface. Therefore, various proposals have been made to improve the wet grip performance in a rubber composition used in a tire.

For example, JP-A-2014-105242 discloses that special silica having a branched structure is blended to a rubber composition containing a conjugated diene polymer obtained by reacting an alkoxysilane compound at a terminal, thereby improving fuel economy, wet grip performance, and abrasion resistance.

JP-A-2016-104840 discloses that dry silica treated with a silicone oil is blended to a rubber composition together with a silane coupling agent, thereby improving low rolling resistance performance, wet performance, and rubber hardness.

However, the wet grip performance and the hardness are conflicting performance, that is, for example, the wet grip performance is reduced when the hardness is increased, and thus it is difficult to achieve both the wet grip performance and the hardness.

### SUMMARY OF THE INVENTION

An object of the invention is to provide a rubber composition capable of improving conflicting performance regarding wet grip performance and hardness, and a tire using the rubber composition.

A rubber composition according to an embodiment of the invention contains a diene rubber and silica, in which a value Dm/Rg obtained by dividing a mass fractal dimension Dm of a silica aggregate by an inertia radius Rg of the silica aggregate is 0.20 nm⁻¹ or more, the inertia radius Rg being obtained by irradiating a vulcanized rubber obtained by vulcanizing the rubber composition with X-rays to perform a small-angle X-ray scattering measurement, and the mass fractal dimension Dm being obtained by irradiating the vulcanized rubber with X-rays to perform an ultra-small angle X-ray scattering measurement.

A vulcanized rubber according to an embodiment of the invention is obtained by vulcanizing a rubber composition containing a diene rubber and silica, in which a value Dm/Rg obtained by dividing a mass fractal dimension Dm of a silica aggregate by an inertia radius Rg of the silica aggregate is 0.20 nm⁻¹ or more, the inertia radius Rg being obtained by irradiating the vulcanized rubber with X-rays to perform a small-angle X-ray scattering measurement, and the mass fractal dimension Dm being obtained by irradiating the vulcanized rubber with X-rays to perform an ultra-small angle X-ray scattering measurement.

The rubber composition may further contain a nitrogen-containing alkoxysilane and an alkylalkoxysilane. A content of the silica may be 5 parts by mass to 150 parts by mass with respect to 100 parts by mass of the diene rubber. A total content of the nitrogen-containing alkoxysilane and the alkylalkoxysilane may be 3 mass % to 15 mass % with respect to the content of the silica. A content rate of the nitrogen-containing alkoxysilane in the total content of the nitrogen-containing alkoxysilane and the alkylalkoxysilane may be 10 mol % to 80 mol %. The nitrogen-containing alkoxysilane may have at least one functional group selected from the group consisting of an amino group, a ureido group, an isocyanate group, a cyano group, an azide group, and an amide group.

A tire according to an embodiment of the invention is produced using the above rubber composition.

According to the embodiment of the invention, conflicting performance regarding wet grip performance and hardness can be improved.

### BRIEF DESCRIPTION OF THE DRAWINGS

FIG. 1 is a diagram showing an example of a two-dimensional scattering image in a small-angle X-ray scattering measurement; and

FIG. 2 is a diagram showing an example of a scattering profile in an ultra-small angle X-ray scattering measurement.

### DESCRIPTION OF EMBODIMENTS

A rubber composition according to the present embodiment contains a diene rubber as a rubber component and silica.

The diene rubber refers to a rubber having a repeating unit corresponding to a diene monomer having a conjugated double bond, and has a double bond in a polymer main chain. Specific examples of the diene rubber include various diene rubbers commonly used in the rubber composition, such as a natural rubber (NR), an isoprene rubber (IR), a butadiene rubber (BR), a styrene-butadiene rubber (SBR), a nitrile rubber (NBR), a chloroprene rubber (CR), a styrene-isoprene copolymer rubber, a butadiene-isoprene copolymer rubber, and a styrene-isoprene-butadiene copolymer rubber. These rubbers may be used alone or in combination of two or more kinds thereof. Those obtained by modifying a terminal or a main chain as necessary (for example, a terminal-modified SBR) or those obtained by modification to impart desired characteristics (for example, a modified NR) are also included in the concepts of the diene rubber.

In one embodiment, the diene rubber contains preferably at least one selected from the group consisting of a natural rubber, a styrene-butadiene rubber, and a butadiene rubber. The diene rubber contains more preferably a styrene-butadiene rubber. For example, the diene rubber contains, in 100 parts by mass thereof, the styrene-butadiene rubber in an amount of preferably 50 parts by mass or more, and more preferably 70 parts by mass or more, and may contain only the styrene-butadiene rubber.

The styrene-butadiene rubber may be, for example, a solution-polymerized styrene-butadiene rubber (SSBR) or an emulsion-polymerized styrene-butadiene rubber (ESBR). As the styrene-butadiene rubber, a modified styrene-butadiene rubber in which a terminal or a main chain is modified as necessary may be used.

As the silica, for example, wet silica such as silica made by a wet-type precipitated method or wet silica made by a wet-type gel-method is preferably used. A nitrogen adsorption specific surface area (BET) of the silica according to JIS K6430:2008 Appendix E (multipoint nitrogen adsorption method: BET method) is preferably, for example, 150 m²/g to 250 m²/g. The nitrogen adsorption specific surface area of the silica is more preferably 180 m²/g to 220 m²/g.

A content of the silica is, for example, preferably 5 parts by mass to 150 parts by mass, more preferably 30 parts by mass to 120 parts by mass, still more preferably 50 parts by mass to 100 parts by mass, and may be 60 parts by mass to 90 parts by mass, with respect to 100 parts by mass of the diene rubber.

The rubber composition according to the present embodiment may further contain a nitrogen-containing alkoxysilane and an alkylalkoxysilane. Accordingly, Dm/Rg, which will be described later, is easily set to 0.20 nm⁻¹ or more. A reason for the above is considered as follows. By using the nitrogen-containing alkoxysilane and the alkylalkoxysilane in combination, a part of a silica surface can be kept hydrophilic while the surface is hydrophobized. That is, it is considered that dispersibility of the silica is improved by hydrophobizing the silica surface with the alkylalkoxysilane, and thereby a magnitude (Rg) of a silica aggregate can be reduced. In addition, it is considered that by mediation between dispersed silica particles by an action of a hydrogen bonding site in the nitrogen-containing alkoxysilane, a constant higher-order structure, that is, a mass fractal dimension (Dm) can be easily maintained.

The nitrogen-containing alkoxysilane is an alkoxysilane containing nitrogen atoms in molecules. Examples of the nitrogen-containing alkoxysilane include a compound having an alkoxy group bonded to silicon atoms, and a functional group selected from the group consisting of an amino group, a ureido group, an isocyanate group, a cyano group, an azide group, and an amide group. Those containing nitrogen atoms in molecules among those generally called silane coupling agents can be used.

Specific examples of the nitrogen-containing alkoxysilane include: aminoalkoxysilanes such as 3-aminopropylalkoxysilanes (for example, 3-aminopropyltriethoxysilane and 3-aminopropyltrimethoxysilane), and 3-(2-aminoethylamino)propylalkoxysilanes (for example, 3-(2-aminoethylamino)propyltriethoxysilane, 3-(2-aminoethylamino)propyltrimethoxysilane, and 3-(2-aminoethvlamino)propylmethyldimethoxysilane); ureidoalkoxysilanes such as 3-ureidopropylalkoxysilanes (for example, 3-ureidopropyltriethoxysilane, 3-ureidopropyltrimethoxysilane, 3-ureidopropylmethyldimethoxysilane, and 3-ureidopropylmethyldiethoxysilane), 2-ureidoethylalkoxysilanes (for example, 2-ureidoethyltrimethoxysilane, 2-ureidoethyltriethoxysilane, and 2-ureidoethylmethyldimethoxysilane), and ureidomethylalkoxysilanes (for example, ureidomethyltrimethoxysilane, ureidomethylmethyldimethoxysilane, ureidomethyltriethoxysilane, and ureidomethylmethyldiethoxysilane); isocyanatoalkoxysilanes such as 3-isocvanatopropylalkoxysilanes (for example, 3-isocyanatopropyltriethoxysilane and 3-isocyanatopropyltripropoxysilane), 2-isocyanatoethylalkoxysilanes (for example, 2-isocyanatoethyltrimethoxysilane and 2-isocyanatoethyltriethoxysilane), and isocyanatomethylalkoxysilanes (for example, isocyanatomethyltrimethoxysilane and isocyanatomethyltriethoxysilane); cyanoalkoxysilanes such as 3-cyanopropylalkoxysilanes (for example, 3-cyanopropyltrimethoxysilane and 3-cyanopropyltriethoxysilane); azidoalkoxysilanes such as 3-azidopropylalkoxysilanes (for example, 3-azidopropyltriethoxysilane and 3-azidopropyltrimethoxysilane), 11-azidoundecylalkoxysilanes (for example, 11-azidoundecyltrimethoxysilane); and amide bond-containing alkoxysilanes such as triethoxysilylpropylmaleamic acid. These may be used alone or in combination of two or more thereof.

The alkylalkoxysilane may be an alkyldialkoxysilane, and preferably an alkyltrialkoxysilane. The alkylalkoxysilane preferably has an alkyl group having 3 to 20 carbon atoms, and specifically, an alkyltriethoxysilane represented by the following Formula (1) is preferably used. In the Formula (1), RI represents an alkyl group having 3 to 20 carbon atoms. The alkyl group preferably has 6 to 20 carbon atoms, and more preferably 10 to 20 carbon atoms.

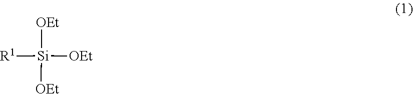

A total content of the nitrogen-containing alkoxysilane and the alkylalkoxysilane in the rubber composition is preferably, for example, 3 mass % to 15 mass % with respect to the content of the silica. That is, the total amount of the nitrogen-containing alkoxysilane and the alkylalkoxysilane is preferably 3 parts by mass to 15 parts by mass with respect to 100 parts by mass of the silica. The total content of the nitrogen-containing alkoxysilane and the alkylalkoxysilane is more preferably 5 mass % to 12 mass %, and still more preferably 8 mass % to 12 mass %, with respect to the content of the silica.

Regarding a blending ratio of the nitrogen-containing alkoxysilane and the alkylalkoxysilane, a content rate of the nitrogen-containing alkoxysilane in the total content of the nitrogen-containing alkoxysilane and the alkylalkoxysilane is, for example, preferably 10 mol % to 80 mol %, more preferably 20 mol % to 60 mol %, and still more preferably 25 mol % to 50 moll.

In addition to the above components, various additives generally used in the rubber composition, such as a filler other than silica, zinc oxide, stearic acid, an antioxidant, an oil, a wax, a vulcanization agent, and a vulcanization accelerator, can be blended in the rubber composition according to the present embodiment. A sulfur-containing silane coupling agent generally blended in a case of blending the silica may be blended, but in one embodiment, it is preferable not to blend the sulfur-containing silane coupling agent.

As the filler, carbon black may be blended in addition to the silica. That is, as the filler, silica may be used alone, or silica and carbon black may be used in combination. Preferably, the filler contains silica as a main component, and a content of carbon black is preferably 10 parts by mass or less, and more preferably 5 parts by mass or less, with respect to 100 parts by mass of the diene rubber.

As the vulcanization agent, sulfur is preferably used. A content of the vulcanization agent is not particularly limited, and is preferably 0.1 parts by mass to 10 parts by mass, more preferably 0.5 parts by mass to 5 parts by mass, and may be 1 part by mass to 3 parts by mass, with respect to 100 parts by mass of the diene rubber.

Examples of the vulcanization accelerator include various vulcanization accelerators such as sulfenamide-based, thiuram-based, thiazole-based, and guanidine-based vulcanization accelerators, which may be used alone or in combination of two or more kinds thereof. A content of the vulcanization accelerator is not particularly limited, and is preferably 0.1 parts by mass to 10 parts by mass, more preferably 0.5 parts by mass to 5 parts by mass, and may be 1 part by mass to 4 parts by mass, with respect to 100 parts by mass of the diene rubber.

The rubber composition according to the present embodiment can be produced by kneading according to a common method by using a mixer such as a Banbury mixer, a kneader, or a roll that is generally used. That is, for example, in a first mixing stage (non-productive kneading step), the silica and an additive other than a vulcanization agent and a vulcanization accelerator are added to the diene rubber. Next, a vulcanization agent and a vulcanization accelerator are added and mixed in the obtained mixture in a final mixing stage (productive kneading step). Accordingly, an unvulcanized rubber composition can be prepared.

In the rubber composition according to the present embodiment, a value (quotient) Dm/Rg obtained by dividing the mass fractal dimension Dm of the silica aggregate by an inertia radius Rg (nm) of the silica aggregate is 0.20 nm⁻¹ or more. A larger Dm/Rg indicates that Rg is smaller and Dm is larger. The small Rg means that the dispersibility of the silica is high, and wet grip performance can be improved by improving the dispersibility of the silica. The large Dm means that the silica maintains a high order structure, and a reinforcing effect by the silica can be enhanced to improve rubber hardness. Therefore, when the Dm/Rg is larger, both wet grip performance and hardness can be more easily achieved, and when Dm/Rg is 0.20 nm⁻¹ or more, conflicting performance regarding the wet grip performance and the hardness can be improved. Dm/Rg is preferably 0.21 nm⁻¹ or more. An upper limit of Dm/Rg is not particularly limited, and may be, for example, 2.0 nm⁻¹ or less, 1.0 nm⁻¹ or less, 0.50 nm⁻¹ or less, or 0.30 nm⁻¹ or less. Here, a value of Dm/Rg is two significant figures, and fraction processing is rounding.

A value of Dm is, for example, preferably 2.0 to 3.5, more preferably 2.5 to 3.5, and may be 2.8 to 3.3. A value of Rg may be, for example, 1.0 nm to 20 nm, 5.0 nm to 20 nm, or 10 nm to 17.5 nm.

The above Dm and Rg are values obtained by measuring by using a vulcanized rubber obtained by vulcanizing the rubber composition. Therefore, the present embodiment may be a vulcanized rubber in which Dm/Rg is 0.20 nm⁻¹ or more. That is, the vulcanized rubber according to one embodiment is obtained by vulcanizing the rubber composition containing the diene rubber and the silica, and has Dm/Rg of 0.20 nm⁻¹ or more. The vulcanized rubber may constitute a part of a rubber product such as a tire, or may constitute the entire rubber product.

Here, the inertia radius Rg of the silica aggregate is obtained by a small-angle X-ray scattering measurement by irradiating the vulcanized rubber with X-rays. The mass fractal dimension Dm of the silica aggregate is obtained by an ultra-small angle X-ray scattering measurement by irradiating the vulcanized rubber with X-rays.

The small-angle X-ray (SAXS) measurement is a method of measuring scattered X-rays having a scattering angle of several degrees or less (normally 10° or less). When the vulcanized rubber is irradiated with the X-rays, the X-rays are scattered by reflecting an electron density of a substance constituting the vulcanized rubber. The inertia radius Rg of the silica aggregate is obtained based on a scattering profile thus obtained.

Specifically, Rg is obtained by a method described in Japanese Patent No. 6578200 (the entire contents are incorporated herein by reference). That is, the vulcanized rubber is stretched by 50% in a direction perpendicular to an orientation direction of the silica, and the small-angle X-ray scattering measurement is performed by irradiating the vulcanized rubber in a stretched state with high luminance X-rays of 10¹⁰ (photons/s/mrad²/mm²/0.1% bw) or more. The orientation direction of the silica can be confirmed by the SAXS measurement on an unstretched vulcanized rubber. For a vulcanized rubber that does not show anisotropy in a two-dimensional scattering image in an unstretched state, the SAXS measurement may be performed by stretching the vulcanized rubber by 50% in any direction.

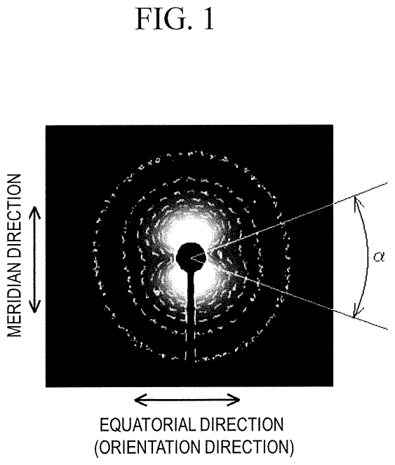

Accordingly, a two-dimensional scattering image showing a magnitude of a scattering intensity as shown in FIG. 1 is obtained. In FIG. 1, the closer to white, the larger the scattering intensity, the closer to black, the smaller the scattering intensity, and a contour line is indicated by a white line (dotted line). A black portion of a scattering center and a black line extending downward from the black portion are shadowed portions by a beam stopper. The two-dimensional scattering image has constrictions on both left and right sides of the scattering center, and a left-right direction in which the constrictions are present is the orientation direction of the silica. The scattering intensity of the two-dimensional scattering image is averaged (circularly averaged) in a predetermined angle range α=30° (a range of 15° on both sides about the orientation direction) in the orientation direction (left and right constrictions) of the silica, thereby obtaining a one-dimensional scattering profile. The scattering profile is a curve showing a magnitude of a scattering intensity I(q) with respect to a scattering vector q(=(4π/λ) sin(θ/2), here, θ is a scattering angle, and λ is a wavelength of the X-ray). The inertia radius Rg of the silica aggregate is obtained by fitting to the obtained scattering profile. Details of measurement conditions are as described in Examples described later.

The ultra-small angle X-ray scattering (USAXS) measurement is a method of measuring scattered X-rays having a scattering angle (normally 0.1° or less) smaller than that of the small angle X-ray scattering. Specifically, the vulcanized rubber is stretched by 50% in a direction perpendicular to an orientation direction of the silica, and a Bonse-Hart USAXS measurement is performed by irradiating the vulcanized rubber in a stretched state with high luminance X-rays of 10¹⁰ (photons/s/mrad²/mm²/0.1% bw) or more. The orientation direction of the silica can be confirmed by the SAXS measurement on an unstretched vulcanized rubber. For the vulcanized rubber that does not show anisotropy in the two-dimensional scattering image in the unstretched state, the USAXS measurement may be performed by stretching the vulcanized rubber by 50% in any direction.

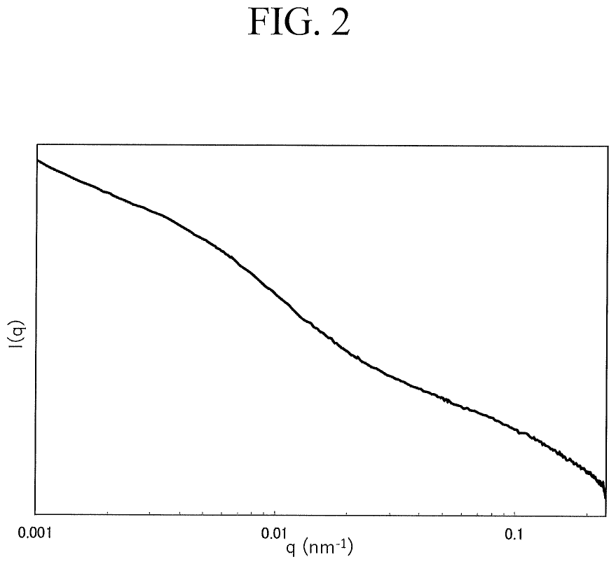

Accordingly, a one-dimensional scattering profile as shown in FIG. 2 is obtained. The scattering profile is a curve showing a magnitude of a scattering intensity I(q) with respect to a scattering vector q (=(4π/λ) sin(θ/2), here, θ is a scattering angle, and λ is a wavelength of the X-ray). The mass fractal dimension Dm of the silica aggregate is obtained by fitting to the obtained scattering profile. Details of measurement conditions are as described in Examples described later.

The rubber composition according to the present embodiment can be suitably used as a rubber composition for a tire. Examples of the tire include pneumatic tires having various uses and sizes, such as a tire for a passenger car and a heavy duty tire for a truck or a bus.

A tire according to an embodiment is a tire produced by using the above rubber composition. That is, the tire contains a vulcanized rubber formed of the above rubber composition. Examples of an application site of the tire include a tread rubber and a sidewall rubber, and preferably a tread rubber.

The tread rubber of the tire has a two-layer structure including a cap rubber and a base rubber, or has a single-layer structure in which the cap rubber and the base rubber are integrated. In the single-layer structure, the tread rubber may be formed of the above rubber composition. In the two-layer structure, the cap rubber on an outer side in contact with a road surface may be formed of the above rubber composition, the base rubber disposed on an inner side of the cap rubber may be formed of the above rubber composition, or both the cap rubber and the base rubber may be formed of the above rubber composition.

A method of manufacturing the tire is not particularly limited. For example, the above rubber composition is molded into a predetermined shape by extrusion according to a common method, and is combined with other members to produce an unvulcanized tire (green tire). For example, the tread rubber is produced by using the above rubber composition, and is combined with other tire members to produce an unvulcanized tire. Thereafter, the tire can be manufactured by vulcanization molding at 140° C. to 180° C., for example.

### EXAMPLES

Hereinafter, Examples will be illustrated, but the invention is not limited to these Examples.

Each rubber composition was prepared according to blending (part by mass) shown in Tables 1 to 3 below. In detail, a diene rubber was masticated for 30 seconds by using a labo mixer (300 cc) manufactured by Daihan Co., Ltd., and then components other than sulfur and a vulcanization accelerator were charged into the labo mixer and kneaded for 240 seconds, and then discharged. The discharged kneaded material was charged into the labo mixer again, kneaded for 180 seconds, and then discharged. Next, the discharged kneaded material was charged into the labo mixer together with sulfur and a vulcanization accelerator, kneaded for 60 seconds, and discharged. The obtained unvulcanized rubber composition was subjected to sheeting by using two rolls so as to have a thickness of 1.0 mm, and then subjected to vulcanization pressing at 160° C. for 20 minutes to obtain a vulcanized rubber sample having a thickness of 1.0 mm.

Details of each component in Tables 1 to 3 are as follows.
S-SBR: “HPR350” manufactured by JSR Corporation, amino group terminal-modified solution-polymerized SBR
Silica: “Nipsil AQ” manufactured by Tosoh Corporation (nitrogen adsorption specific surface area: 205 m²/g)
Sulfur-containing silane coupling agent: “Si75” manufactured by EVONIK Industries
Alkylalkoxysilane: Octadecyltriethoxysilane manufactured by Tokyo Chemical Industry Co., Ltd.
Aminoalkoxysilane: 3-aminopropyltriethoxysilane manufactured by Tokyo Chemical Industry Co., Ltd.
Ureidoalkoxysilane: “1-[3-(triethoxysilyl)propyl]urea (40% to 52% in methanol)” and 3-ureidopropyltriethoxysilane manufactured by Tokyo Chemical Industry Co., Ltd.
Isocyanatoalkoxysilane: 3-isocyanatopropyltriethoxysilane manufactured by Tokyo Chemical Industry Co., Ltd.
Zinc oxide: “Zinc Oxide Grade 3” manufactured by Mitsui Mining & Smelting Co., Ltd.
Stearic acid: “LUNAC S-20” manufactured by Kao Corporation
Sulfur: “Powdered sulfur” manufactured by Tsurumi Chemical Industry Co., Ltd.
Vulcanization accelerator 1: “SOXINOL CZ” manufactured by Sumitomo Chemical Co., Ltd.
Vulcanization accelerator 2: “NOCCELER D” manufactured by Ouchi Shinko Chemical Industrial Co., Ltd.

The expression “molar ratio (%) of nitrogen-containing alkoxysilane” in Tables 1 to 3 is the content rate (mol %) of the nitrogen-containing alkoxysilane in the total content of the nitrogen-containing alkoxysilane and the alkylalkoxysilane. blending amount of the ureidoalkoxysilane in Table 2 is an amount containing methanol in a product.

For each obtained vulcanized rubber sample, the inertia radius Rg and the mass fractal dimension Dm of the silica aggregate were determined, and Dm/Rg was calculated. A measurement method is as follows.

### [Inertia Radius Rg]

A SAXS measurement was performed based on the method described in Japanese Patent No. 6578200. In the measurement, the SAXS measurement was performed on an unstretched sample to confirm an orientation direction of the silica, and then the sample was stretched by 50% in a direction perpendicular to the orientation direction and irradiated with X-rays in a stretched state. The SAXS measurement was performed under the following measurement conditions by using a beam line BL08B2 of SPring-8 of Japan Synchrotron Radiation Research Institute as a synchrotron that emits high luminance X-rays.
Wavelength of incident X-ray: 0.15 nm
Camera length: 6 m
Exposure time: 1 second
q range: 0.015 nm⁻¹ to 0.8 nm⁻¹
Detector: PILATUS

From a two-dimensional scattering image obtained by the small-angle X-ray scattering measurement, a scattering intensity was circularly averaged in an angle range α=30° in constrictions on both left and right sides of a scattering center to obtain a one-dimensional scattering profile. The inertia radius Rg of the silica aggregate was obtained by fitting to the obtained scattering profile. The fitting was performed by a least squares method using a fitting function in the following equation (equation source: G. Beaucage, J. Appl. Cryst. 28, 717-728 (1995)).

$$I ( q ) = {\sum }_{i = 1}^{n} ( {G}_{i} exp ( - \frac{{q}^{2} {R}_{gi}^{2}}{3} ) + {B}_{i} exp ( - \frac{{q}^{2} {R}_{g ( i + 1 )}^{2}}{3} ) \times {\{ {[ erf ( {qkR}_{gi} / \sqrt{6} ) ]}^{3} / q \}}^{{P}_{i}} )$$

In the equation, I(q) is the scattering intensity, Gᵢ, Bᵢ, k, Pᵢ are regression coefficients, and q is a scattering vector and an independent variable. R_{gi} represents an aggregate radius (inertia radius Rg of silica aggregate).

### [Mass Fractal Dimension Dm]

A USAXS measurement using a Bonse-Hart optical system was performed in an Al experimental hatch of BL24XU of SPring-8 of Japan Synchrotron Radiation Research Institute to obtain a one-dimensional scattering curve. In the measurement, the orientation direction of the silica was confirmed by the SAXS measurement performed in advance, the sample was stretched by 50% in the direction perpendicular to the orientation direction, and the sample in a stretched state was irradiated with X-rays. In the X-ray irradiation, reflection was performed four times using a collimator crystal Si (220) before the X-rays entering the sample, reflection was performed four times using an analyzer crystal Si (220) after the X-rays scattering in the sample, the reflected light was detected by using an APD detector, and de-smearing was performed. Measurement conditions were as follows.
Beam size: 0.2 mm×0.3 mm
Wavelength of incident X-ray: 0.124 nm
q range: 0.001 nm⁻¹ to 0.2 nm⁻¹

The mass fractal dimension Dm of the silica aggregate was obtained by fitting to the obtained one-dimensional scattering curve. The fitting was performed by a least squares method using a fitting function in the following equation (equation source: Koga, T.; Hashimoto, T.; Takenaka, M.; Aizawa, K.; Amino, N.; Nakamura, M.; Yamaguchi, D.; Koizumi, S.: Macromolecules, 2008, 41, 453 (2008)).

I(q)=A exp(−q²R_{g}²/3)q^{-p}^{₁}+B exp(−q²R_{g}²/3)+C exp(−q²Rₛ²/3)×[erf(qR_{g}/\sqrt{6})]^{3D}^{ₘ}q^{-D}^{ₘ}+D exp(−q²Rₛ²/3)+E[erf(qRₛ/\sqrt{6})]^{3(2d-D}^{ₛ}⁾q^{-(2d-D}^{ₛ}⁾

In the equation, I(q) is the scattering intensity, A, B, C, D, E, p₁ are regression coefficients, and q is a scattering vector and an independent variable. R_{g} represents an agglomerate radius (inertia radius of silica agglomerate), Rₛ represents a silica aggregate diameter (inertia radius of silica aggregate), Dₘ represents a mass fractal dimension, and Dₛ represents the surface fractal dimension. d represents a dimension of an Euclidean space, where d=3

For each unvulcanized rubber composition obtained above, hardness and wet grip performance were measured by using a sample vulcanized at 160° C. for 20 minutes, and a balance (Hs*Wet index) therebetween was evaluated. Measurement and evaluation methods are as follows.

### [Hardness]

The hardness was measured at 23° C. by using a type A durometer in accordance with JIS K6253-3:2012, and values are indicated as indexes using values in Comparative Example 1 in Tables 1 and 2 and a value in Comparative Example 10 in Table 3 each set as 100. The larger the index, the higher the hardness, and the better the steering stability when the tire is produced.

### [Wet Grip Performance]

A loss coefficient tanδ was measured at a frequency of 10 Hz, an electrostatic strain of 10%, a dynamic strain of 1%, and a temperature of 0° C. by using a viscoelasticity tester manufactured by Ueshima Seisakusho Co., Ltd. Values are indicated as indexes using values in Comparative Example 1 in Tables 1 and 2 and a value in Comparative Example 10 in Table 3 each set as 100. The larger the index, the larger the tan δ, and the better the wet grip performance when the tire is produced.

### [Hs*Wet Index]

The Hs*Wet index was calculated according to the following equation based on the hardness index (Hs) and wet grip performance index (Wet) obtained above. The larger the index, the higher the effect of improving the conflicting performance regarding the wet grip performance and the hardness.

(Hs*Wet index)=(Hs×Wet)/100

TABLE 1

| | Comparative | Comparative | Comparative | | | | | Comparative | Comparative |
|---|---|---|---|---|---|---|---|---|---|
| | Example 1 | Example 2 | Example 3 | Example 1 | Example 2 | Example 3 | Example 4 | Example 4 | Example 5 |
| Blending (part by mass) | | | | | | | | | |
| S-SBR | 100 | 100 | 100 | 100 | 100 | 100 | 100 | 100 | 100 |
| Silica | 75 | 75 | 75 | 75 | 75 | 75 | 75 | 75 | 75 |
| Zinc oxide | 2.0 | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 | 2.0 |
| Sulfur-containing | 6.0 | — | — | — | — | — | — | — | — |
| silane coupling agent | | | | | | | | | |
| Alkylalkoxysilane | — | — | 1.7 | 2.0 | 5.0 | 7.5 | 9.0 | 9.2 | 10.0 |
| Aminoalkoxysilane | — | 5.3 | 4.4 | 4.2 | 2.7 | 1.3 | 0.5 | 0.4 | — |
| Sulfur | 1.8 | 1.8 | 1.8 | 1.8 | 1.8 | 1.8 | 1.8 | 1.8 | 1.8 |
| Vulcanization | 1.3 | 1.3 | 1.3 | 1.3 | 1.3 | 1.3 | 1.3 | 1.3 | 1.3 |
| accelerator 1 | | | | | | | | | |
| Vulcanization | 1.8 | 1.8 | 1.8 | 1.8 | 1.8 | 1.8 | 1.8 | 1.8 | 1.8 |
| accelerator 2 | | | | | | | | | |
| Molar ratio (%) of | 0 | 100 | 83 | 80 | 50 | 25 | 10 | 8 | 0 |
| nitrogen-containing | | | | | | | | | |
| alkoxysilane | | | | | | | | | |
| Inertia radius Rg (nm) | 18.0 | 19.5 | 18.8 | 16.5 | 13.5 | 12.1 | 13.3 | 14.0 | 14.2 |
| Mass fractal | 3.4 | 3.4 | 3.2 | 3.3 | 3.2 | 3.1 | 2.8 | 2.7 | 2.7 |
| dimension Dm | | | | | | | | | |
| Dm/Rg (nm⁻¹) | 0.19 | 0.17 | 0.17 | 0.20 | 0.24 | 0.26 | 0.21 | 0.19 | 0.19 |
| Evaluation (index) | | | | | | | | | |
| Hardness | 100 | 116 | 108 | 105 | 100 | 93 | 92 | 86 | 84 |
| Wet grip performance | 100 | 84 | 92 | 98 | 126 | 135 | 118 | 115 | 110 |
| Hs*Wet index | 100 | 97 | 100 | 103 | 126 | 126 | 108 | 100 | 92 |

TABLE 2

| | Comparative | Comparative | | | Comparative | Comparative | | | Comparative |
|---|---|---|---|---|---|---|---|---|---|
| | Example 1 | Example 6 | Example 5 | Example 6 | Example 7 | Example 8 | Example 7 | Example 8 | Example 9 |
| Blending (part by mass) | | | | | | | | | |
| S-SBR | 100 | 100 | 100 | 100 | 100 | 100 | 100 | 100 | 100 |
| Silica | 75 | 75 | 75 | 75 | 75 | 75 | 75 | 75 | 75 |
| Zinc oxide | 2.0 | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 | 2.0 |
| Sulfur-containing | 6.0 | — | — | — | — | — | — | — | — |
| silane coupling agent | | | | | | | | | |
| Alkylalkoxysilane | — | — | 2.5 | 3.8 | 5.0 | — | 2.5 | 3.8 | 5.0 |
| Ureidoaikoxysilane | — | 6.3 | 3.2 | 1.6 | — | — | — | — | — |
| Isocyanatoalkoxysilane | — | — | — | — | — | 3.0 | 1.5 | 0.7 | — |
| Sulfur | 1.8 | 1.8 | 1.8 | 1.8 | 1.8 | 1.8 | 1.8 | 1.8 | 1.8 |
| Vulcanization | 1.3 | 1.3 | 1.3 | 1.3 | 1.3 | 1.3 | 1.3 | 1.3 | 1.3 |
| accelerator 1 | | | | | | | | | |
| Vulcanization | 1.8 | 1.8 | 1.8 | 1.8 | 1.8 | 1.8 | 1.8 | 1.8 | 1.8 |
| accelerator 2 | | | | | | | | | |
| Molar ratio (%) of | 0 | 100 | 50 | 25 | 0 | 100 | 50 | 25 | 0 |
| nitrogen-containing | | | | | | | | | |
| alkoxysilane | | | | | | | | | |
| Inertia radius Rg (nm) | 18.0 | 18.0 | 13.5 | 12.9 | 15.7 | 20.0 | 14.9 | 13.3 | 15.7 |
| Mass fractal | 3.4 | 3.3 | 3.3 | 3.0 | 2.7 | 3.3 | 3.2 | 3.1 | 2.7 |
| dimension Dm | | | | | | | | | |
| Dm/Rg (nm⁻¹) | 0.19 | 0.18 | 0.24 | 0.23 | 0.17 | 0.17 | 0.21 | 0.23 | 0.17 |
| Evaluation (index) | | | | | | | | | |
| Hardness | 100 | 120 | 107 | 105 | 89 | 118 | 112 | 105 | 89 |
| Wet grip performance | 100 | 79 | 102 | 104 | 110 | 78 | 93 | 103 | 110 |
| Hs*Wet index | 100 | 94 | 109 | 110 | 98 | 92 | 105 | 108 | 98 |

TABLE 3

| | Compar- | Compar- | | Compar- |
|---|---|---|---|---|
| | ative | ative | | ative |
| | Example | Example | Example | Example |
| | 10 | 11 | 9 | 12 |
| Blending | | | | |
| (part by mass) | | | | |
| S-SBR | 100 | 100 | 100 | 100 |
| Silica | 50 | 50 | 50 | 50 |
| Zinc oxide | 2.0 | 2.0 | 2.0 | 2.0 |
| Stearic acid | 2.0 | 2.0 | 2.0 | 2.0 |
| Sulfur-containing | 4.0 | — | — | — |
| silane coupling | | | | |
| agent | | | | |
| Alkylalkoxysilane | — | — | 1.7 | 3.3 |
| Aminoalkoxysilane | — | 1.8 | 0.9 | — |
| Sulfur | 1.8 | 1.8 | 1.8 | 1.8 |
| Vulcanization | 1.3 | 1.3 | 1.3 | 1.3 |
| accelerator 1 | | | | |
| Vulcanization | 1.8 | 1.8 | 1.8 | 1.8 |
| accelerator 2 | | | | |
| Molar ratio (%) of | 0 | 100 | 50 | 0 |
| nitrogen-containing | | | | |
| alkoxysilane | | | | |
| Inertia radius | 22.2 | 23.3 | 16.3 | 22.2 |
| Rg (nm) | | | | |
| Mass fractal | 3.2 | 3.3 | 3.2 | 2.8 |
| dimension DM | | | | |
| Dm/Rg (nm⁻¹) | 0.14 | 0.14 | 0.20 | 0.13 |
| Evaluation (index) | | | | |
| Hardness | 100 | 100 | 100 | 91 |
| Wet grip | 100 | 100 | 107 | 110 |
| performance | | | | |
| Hs*Wet index | 100 | 100 | 107 | 100 |

Results are as shown in Tables 1 to 3. In Comparative Example 1, the sulfur-containing silane coupling agent is added to a silica compound, while in Comparative Example 2, the sulfur-containing silane coupling agent is replaced with an aminoalkoxysilane. In Comparative Example 2, Dm/Rg is as low as 0.17 nm⁻¹ and the hardness is improved, but the wet grip performance is significantly deteriorated. In Comparative Examples 3 and 4, although the aminoalkoxysilane and the alkylalkoxysilane are used in combination, Dm/Rg is less than 0.20 nm⁻¹, and the conflicting performance regarding the hardness and the wet grip performance is not improved. On the other hand, in Examples 1 to 4 in which Dm/Rg is 0.20 nm⁻¹ or more, the conflicting performance regarding the hardness and the wet grip performance is improved as compared with Comparative Example 1, and in particular, in Examples 2 and 3, the improvement effect is high, and in Example 2, the balance between the hardness and the wet grip performance is achieved at a high level.

As shown in Table 2, in Examples 5 to 8 in which a ureidoalkoxysilane or an isocyanatoalkoxysilane is used instead of the aminoalkoxysilane as the nitrogen-containing alkoxysilane, as Dm/Rg is 0.20 nm⁻¹ or more, the conflicting performance regarding the hardness and the wet grip performance is improved as compared with Comparative Example 1 serving as a reference, and in particular, in Examples 5, 6, and 8, the hardness and the wet grip performance are improved in a balanced manner.

In the experimental examples shown in Table 3, a blending amount of the silica is 50 parts by mass with respect to 100 parts by mass of the diene rubber, and is reduced as compared with the experimental examples shown in Tables 1 and 2. Also in this case, in Example 9 in which Dm/Rg is 0.20 nm⁻¹ or more, the conflicting performance regarding the hardness and the wet grip performance is improved as compared with Comparative Example 10 serving as a reference.

In various numerical ranges described in the specification, upper limit values and lower limit values thereof can be freely combined, and it is construed that all combinations thereof are described in the present specification as preferable numerical ranges. In addition, the description of the numerical range of “X to Y” means X or more and Y or less.

What is claimed is:

1. A rubber composition comprising:
a diene rubber; and
silica, wherein
a value Dm/Rg obtained by dividing a mass fractal dimension Dm of a silica aggregate by an inertia radius Rg of the silica aggregate is 0.20 nm⁻¹ or more, the inertia radius Rg being obtained by irradiating a vulcanized rubber obtained by vulcanizing the rubber composition with X-rays to perform a small-angle X-ray scattering measurement, and the mass fractal dimension Dm being obtained by irradiating the vulcanized rubber with X-rays to perform an ultra-small angle X-ray scattering measurement.

2. The rubber composition according to claim 1, further comprising:
a nitrogen-containing alkoxysilane; and
an alkylalkoxysilane.

3. The rubber composition according to claim 2, wherein
a content of the silica is 5 parts by mass to 150 parts by mass with respect to 100 parts by mass of the diene rubber, a total content of the nitrogen-containing alkoxysilane and the alkylalkoxysilane is 3 mass % to 15 mass % with respect to the content of the silica, and a content rate of the nitrogen-containing alkoxysilane in the total content of the nitrogen-containing alkoxysilane and the alkylalkoxysilane is 10 mol % to 80 mol %.

4. The rubber composition according to claim 2, wherein
the nitrogen-containing alkoxysilane has at least one functional group selected from the group consisting of an amino group, a ureido group, an isocyanate group, a cyano group, an azide group, and an amide group.

5. The rubber composition according to claim 2, wherein
the alkylalkoxysilane is an alkyltriethoxysilane represented by the following Formula (1) 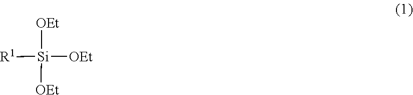
in the Formula (1), R¹ represents an alkyl group having 3 to 20 carbon atoms.

6. A pneumatic tire, which is produced using the rubber composition according to claim 1.

7. A pneumatic tire, which is produced using the rubber composition according to claim 2.

8. A pneumatic tire, which is produced using the rubber composition according to claim 3.

9. A pneumatic tire, which is produced using the rubber composition according to claim 4.

10. A pneumatic tire, which is produced using the rubber composition according to claim 5.

11. A vulcanized rubber obtained by vulcanizing a rubber composition containing a diene rubber and silica, wherein
a value Dm/Rg obtained by dividing a mass fractal dimension Dm of a silica aggregate by an inertia radius Rg of the silica aggregate is 0.20 nm⁻¹ or more, the inertia radius Rg being obtained by irradiating the vulcanized rubber with X-rays to perform a small-angle X-ray scattering measurement, and the mass fractal dimension Dm being obtained by irradiating the vulcanized rubber with X-rays to perform an ultra-small angle X-ray scattering measurement.

12. The vulcanized rubber according to claim 11, wherein
the rubber composition further contains a nitrogen-containing alkoxysilane and an alkylalkoxysilane.

13. The vulcanized rubber according to claim 12, wherein
a content of the silica is 5 parts by mass to 150 parts by mass with respect to 100 parts by mass of the diene rubber, a total content of the nitrogen-containing alkoxysilane and the alkylalkoxysilane is 3 mass % to 15 mass % with respect to the content of the silica, and a content rate of the nitrogen-containing alkoxysilane in the total content of the nitrogen-containing alkoxysilane and the alkylalkoxysilane is 10 mol % to 80 mol %.

14. The vulcanized rubber according to claim 12, wherein
the nitrogen-containing alkoxysilane has at least one functional group selected from the group consisting of an amino group, a ureido group, an isocyanate group, a cyano group, an azide group, and an amide group.

15. The vulcanized rubber according to claim 12, wherein
the alkylalkoxysilane is an alkyltriethoxysilane represented by the following Formula (1) 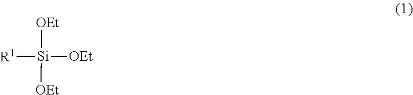
in the Formula (1), Ryrepresents an alkyl group having 3 to 20 carbon atoms.
